(19) United States
(12) Patent Application Publication
(10) Pub. No.: US 2012/0197669 A1
(43) Pub. Date: Aug. 2, 2012

(54) Determining Cost of Auto Insurance

(76) Inventors: Thejovardhana S. Kote, San Francisco, CA (US); Jerald Jariyasunant, San Francisco, CA (US)

(21) Appl. No.: 13/358,720

(22) Filed: Jan. 26, 2012

Related U.S. Application Data
(60) Provisional application No. 61/436,775, filed on Jan. 27, 2011.

(51) Int. Cl. G06Q 40/08

(52) U.S. Cl. 705/4

(57) ABSTRACT

A system for analyzing sensor data output from a mobile communications appliance to adjust insurance premiums for consumers includes an Internet-connected server; and software executing on the server from a non-transitory physical medium, the software providing a first function for collecting raw data from the mobile communications appliance, a second function for analyzing the raw data in light of results of previous data analyses, and a third function for adjusting a standing insurance premium rate associated with the mobile communications appliance.

### CROSS-REFERENCE TO RELATED DOCUMENTS

The present invention claims priority to a U.S. provisional patent application No. 61/436,775 entitled Determining Cost of Auto Insurance, filed on Jan. 27, 2011, disclosure of which is incorporated herein at least by reference.

### BACKGROUND OF THE INVENTION

### Field of the Invention

The present invention is in the field of telematics and pertains particularly to methods and apparatus for managing the costs of insurance for vehicle operation through a process of telematics.

In the field of telematics, insurance companies collect data about vehicle usage and driver behavior while the driver is operating an insured vehicle in the field. Actual data about vehicle operation, driving conditions, and behavioral data about the driver enable the company to get a more accurate picture for risk determination, which is critical in setting appropriate rates for insurance accordingly. Current data collection systems often require a hardware device to be installed within a targeted vehicle. The hardware may transmit data over data networks like cellular phone networks. One potential drawback of this technique is that hardware and network charges to implement this solution are expensive. Moreover, the approach is not flexible relative to the consumer input or direction of the process. Privacy concerns among consumers has risen in response to these in-vehicle hardware solutions.

Therefore, what is needed is a system for monitoring vehicle usage and driver behavior through hand-held devices, such information input into insurance rating applications to determine more relevant rates for vehicle operators.

### SUMMARY OF THE INVENTION

The problem stated above is that the ability to mitigate results of raw data analysis is desirable for a system that adjusts vehicle insurance rates based on operator behaviors, but many of the conventional means for determining cost of vehicle insurance based on operator behaviors, also exclude user compliance in implementing corrective measures in the field. The inventors therefore considered functional components of an insurance underwriting system, looking for elements that exhibit interoperability that could potentially be harnessed to provide insurance rate adjustment based on operator behaviors in a manner that would also reduce risk.

Every insurance rate is propelled, at least in part, by driver behaviors, one by-product of which is an abundance of conscientious drivers paying higher insurance rates to compensate for affordable insurance for poorer drivers. Most such insurance companies employ servers executing software to analyze driver behaviors gleaned from research and in some cases real-time behavioral analyses, and network servers and software applications are typically a part of such apparatus.

The present inventor realized in an inventive moment that if, at the point of operation, negative driving behaviors of vehicle operators could be analyzed in near real time and could be mitigated through real-time communication to vehicle operators, lower risk associated with insuring operators might result. The inventor therefore constructed a unique real-time data collection and analysis system and service for in-field vehicle operators that allowed users to mitigate potentially poor driving data by implementing corrective behaviors in the field based on corrective communicative input received in near real time from the service provider. A significant reduction in assessed risk results, with no impediment to the rate-adjusting process.

Accordingly, in one embodiment, a system for analyzing sensor data output from a mobile communications appliance to adjust insurance premiums for consumers is provided and includes an Internet-connected server and software executing on the server from a non-transitory physical medium, the software providing a first function for collecting raw data from the mobile communications appliance, a second function for analyzing the raw data in light of results of previous data analyses, and a third function for adjusting a standing insurance premium rate associated with the mobile communications appliance.

In one embodiment, the sensor data output includes one or a combination of rate of acceleration, continued average speed, rate of deceleration, incidence of shock force, incidence of centrifugal force, incidence of proximity to one or more objects, and frequency of lane change. In this embodiment, the sensors include one or a combination of an accelerometer, a gyroscope, a location sensor, a light sensor, a proximity sensor, a microphone, a visual sensor, and a magnetometer. In one embodiment, the mobile communications appliance is one of a cellular telephone, a notebook, a smart phone, an android device, or a hand-held navigation unit.

In one embodiment, the sensors or combination thereof reside internally and or externally on the mobile communications appliance. In one embodiment, the results of analysis of the data are forwarded to an insurance company underwriter for review, comparison, and potential premium adjustment. In another embodiment, the results of analysis of the data are forwarded to an automated system underwriter for automated review, comparison, and potential premium adjustment. In one embodiment, the mobile communications appliance is docked to the vehicle while driving data is collected. In an embodiment supporting a visual sensor, the visual sensor is a camera capable of recording video.

In one embodiment, the system further includes a fourth function for forging a communications link to a user operating the mobile communications appliance. In a variation of this embodiment, the system communicates correctional information for implementation to provide mitigation to the final data analysis.

According to an aspect of the invention, a method for determining a rate adjustment for a vehicle insurance policy is provided and includes the steps (a) monitoring one or more sensors operating on a mobile communications device while the vehicle is being operated, (b) collecting data output from the one or more sensors, (c) analyzing the data in light of previous data analyses, (d) opening a communications link to the mobile communications appliance, (e) communicating one or more correctional messages to mitigate results of the analysis, and (f) using the final data results to raise or lower the rate of premium paid on the insurance policy covering the vehicle operation.

According to one aspect of the method, in step (a), the sensors include one or a combination of an accelerometer, a gyroscope, a location sensor, a light sensor, a proximity sensor, a microphone, a visual sensor, and a magnetometer. In this aspect, in step (b), the sensor data output includes one or a combination of rate of acceleration, continued average speed, rate of deceleration, incidence of shock force, incidence of centrifugal force, incidence of proximity to one or more objects, and frequency of lane change.

In one aspect of the method, in step (c), the previous results of data analyses are quantified and averaged over a pre-specified period of time. In one aspect, in step (d), the communications link is one of a text link or a voice link. In a variation of this aspect, in step (e), the voice link carries a live or automated voice communication from the insurance company to the operator of the mobile communications appliance. In another variation of the aspect, in step (e), the text link carries a live or automated text communication from the insurance company to the operator of the mobile communications appliance.

In one aspect of the method, the mobile communications appliance is one of a cellular telephone, a notebook, a smart phone, an android device, or a hand-held navigation unit. In one aspect, in step (a), the one or more sensors reside internally and or externally on the mobile communications appliance.

### BRIEF DESCRIPTION OF THE DRAWING FIGURES

FIG. 1 is an architectural overview of a communications network supporting telematics according to an embodiment of the present invention.

FIG. 2 is a process flow chart depicting steps for collecting and processing vehicle operation data and for providing mitigating correction recommendations in real time according to the embodiment of FIG. 1.

FIG. 3 is a process flow chart depicting steps for processing collected data for the purpose of rate adjustment according to the embodiment of FIG. 1.

### DETAILED DESCRIPTION

The inventors provide a unique telematics system and methods that enable vehicle operators to mitigate abhorrent driving behaviors in near real time to help lower insurance risk overall in the rating adjustment process. The present invention will be described in enabling detail using the following examples, which may describe more than one relevant embodiment falling within the scope of the present invention.

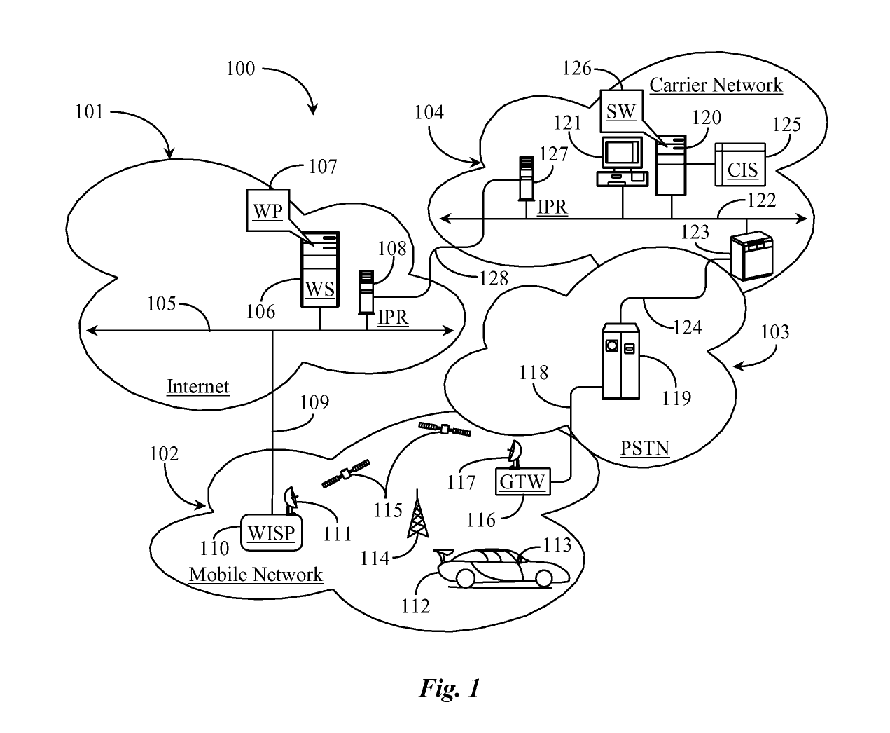

FIG. 1 is an architectural overview 100 of a communications network supporting telematics according to an embodiment of the present invention. Communications network 100 includes the Internet network 101. Internet network 101 is also represented in this example by an Internet network backbone 105. Network backbone 105 includes all of the lines, equipment, and access points that make up the Internet as a whole, including any connected sub-networks. Therefore, there are no geographic limitations to the practice of the present invention.

Internet backbone 105 supports a web server (WS) 106. WS 106 includes a non-transitory physical medium that contains all of the software and data required to enable server function as a web page server. A third-party web hosting service company may maintain WS 106. In one embodiment, the service-providing company of the service of the present invention maintains WS 106. WS 106 contains a web page (WP) 107. WP 107 serves as a consumer access point for registering to participate in the telematics service of the present invention. WP 107 may include various interfaces for consumer interaction with the providing company. One such interface may be provided through WP 107 for registering users for the telematics service of the present invention.

There may be variation in various embodiments of the invention as to the functionality that is implemented at the server side as opposed to the client side. For client appliances that are not robust more functionality will be provided on the server side. On the other hand in many embodiments a great deal of functionality may be provided on the client appliance.

Communications network 100 includes a service network 104. Service network 104 is also represented in this example by a local area network (LAN) backbone 122. LAN 122 is hosted by the service providing company such as an insurance company. LAN 122 may instead be a corporate wide area network (WAN) instead of a LAN without departing from the spirit and scope of the present invention. It is noted herein that the described networks may include both wireless and wired access points without parting from the spirit and scope of the present invention.

LAN 122 has connectivity to Internet backbone 105 via an Internet protocol router (IPR) 127. IPR 127 includes a non-transitory physical medium that contains all of the software and data required to enable routing of network data between external networks. IPR 127 is connected to an IPR 108 supported by Internet backbone 105 by way of an Internet access line 128. IPR 108 includes a non-transitory physical medium that contains all of the software and data required to enable routing of network data between external networks.

LAN 122 supports a telematics server 120. Telematics server 120 includes a non-transitory physical medium that contains all of the software and data required to enable telematics service related to vehicle operation monitoring and reporting for insurance purposes. Server 120 is linked to WP 107 for redirect to consumers who successfully register for the telematics service of the present invention. Server 120 hosts software (SW) 126 to practice the telematics service. SW 126 resides on and is executable from a non-transitory physical medium internal to or otherwise coupled to server 120. SW 120 includes a first function for collecting raw vehicle operation data in real time, a second function for analyzing and processing the collected data, and a third function for using the results of processing to mitigate insurance risk and to provide accurate information for setting rate policy for registered consumers.

Server 120 is, in this embodiment, an Internet-connected server by virtue of connectivity to Internet backbone 105 through IPR 127, Internet access line 128, and IPR 108. Internet connectivity for server 120 is constant in a preferred embodiment. However, that preference should not be construed as a limitation to practice of the present invention. In other embodiments, server 120 may be periodically connected to the Internet for pre-specified periods without departing from the spirit and scope of the present invention. Server 120 has connection to a mass data repository 125 that serves as a customer information system (CIS) and database. CIS 125 may be an optical storage facility, a magnetic storage facility, a redundant array of integrated disks (RAID), or any other form of data storage facility. CIS 125 includes customer account information, customer contact data, customer account histories, customer vehicle operation data, including recent and historical data, and historical-to-current insurance rating information for customers.

LAN 122 supports an administrator workstation 121. Workstation 121 serves as a LAN connected computing station that enables an administrator to interact with the telematics service of the present invention. Administration station 121 has access to server 120 and an authorized administrator may log-into server 120 to review records, obtain data useful in underwriting, and so on. In one embodiment of the invention, an administrator or knowledge worker may physically monitor any ongoing data collection and analysis sequence for any registered user and review, make notes, initiate communication, report a problem, and so on.

LAN 122 supports a telephony server 123. Telephony server 123 includes a non-transitory physical medium that contains all of the software and data required to enable telephony services such as human and/or machine operated outbound voice calling and human and/or machine data calling including digital messaging service capabilities. Telephony server 123 is used by the telematics service to initiate contact with consumers whom are operating insurance-covered vehicles in the field that are registered with the service of the present invention. The inventor recognizes that calling a customer (client) via a cellular device while the client may be operating a vehicle is not a good idea, but it is recognized as well that communication with the client may often be necessary. In some cases such outgoing messaging from the server side may be restricted to text messaging. Another alternative is that client devices may be configured so a call from the server side will trigger the client appliance to go directly to voice mail for the caller ID without ring tone. There are other possibilities to be sure an unsafe situation is not created.

Communications network 100 includes a public switched telephone network (PSTN) 103. PSTN 103 represents a local segment of the PSTN network. PSTN 103 includes a local telephony switch 119. Switch 119 may be a service control switch, an automated call distributor, or a private branch exchange switch without departing for the spirit and scope of the present invention. Switch 119 is connected via a telephone trunk 124 to telephony server 123 in service network 104. Switch 119 is connected to a wireless network gateway (GTW) 116 deployed in a mobile wireless network 102, referred to hereinafter as mobile network 102. Mobile network 102 represents any wireless carrier network that provides telephony and Internet access services to consumers. Mobile network 102 may be integrated with other mobile networks operated by other wireless service providers to expand network coverage for mobile communications appliances such as cellular telephones and the like.

Mobile network 102 offers Internet connectivity through a wireless Internet service provider (WISP) 110. WISP 110 has connection to Internet backbone 105 via an Internet access line 109. A consumer operating a vehicle 112 has a mobile communications appliance 113 powered on for Internet access and communication. Mobile communications appliance 113 may or may not be stationed or docked in a hands free operating receptacle or docking station that may be original equipment or an accessory integrated into the vehicle electronics system. Mobile communications appliance 113 may be a cellular telephone, a smart phone, an android device, a laptop or notebook computer, an iPAD™, or any other appliance that is enabled for telephony and Internet access and navigation. In one embodiment, the mobile communications appliance is a hand-held navigation unit adapted for telephony function and Internet access.

In a preferred embodiment, mobile appliance 113 includes a global positioning system (GPS) capability for reporting location. Mobile communications appliance 113 includes at least one sensor for sensing motion such as an accelerometer for measuring acceleration, deceleration, and sustained or continued average speed. In one embodiment, the mobile appliance further includes a proximity sensor for measuring distance between the mobile communications appliance and nearby objects. In one embodiment, the accelerometer maybe enhanced to provide information relative to orientation, vibration, and shock. In one embodiment the accelerometer is a micro-electro-mechanical-system (MEMS) accelerometer capable of measuring acceleration, deceleration, sustained speed, pitch, yaw, shock, orientation, and vibration. Mobile appliance 113 may also include a light sensor for measuring ambient light or a magnetometer for measuring magnetic fields.

In one implementation of the present invention, an operator of vehicle 112 may have mobile communications appliance 113 powered on and connected to the Internet during the collection of raw sensor data from the appliance. But Internet connection is not strictly necessary. In a preferred embodiment the client appliance will collect data and store it, and transfer to the server side may be on an intermittent basis.

In one example of the connection process, mobile communications appliance 113 is connected to WISP 110 and has been redirected from WS 106 off of WP 107 to server 120 running SW 126. SW 126 continuously or periodically monitors the sensor data from mobile appliance 113 while the operator is operating vehicle 112. As operation continues, the system gleans information such as actual mileage, future mileage (planned route information), acceleration, rates, deceleration rates, continued speeds, rate of lane changes, proximity data, GPS information (location), and the like. Raw sensor data may include any sensor data that provides useful information that can be entered into an algorithm driven process for analyzing the data against standards, thresholds, etc.

In one embodiment, threshold data may be established during a trip or portion of a planned route. For example, if a speed limit is 70 miles per hour over a stretch of a planned route, real-time sensor data analysis can identify one or more red-flag data points, such as when the driver of the vehicle exceeds the speed limit for that stretch. Two or more breached of the established threshold may trigger communication from the system to the driver for the purposes of mitigating the current driver behavior. A text message or a voice message might be delivered to mobile appliance 113 while the vehicle is in operation, but only in a circumstance where an unsafe situation will not be created. The message may indicate one or more red flag data points and suggest a reduction overall in driving speed. In another example, a vehicle operator may be changing lanes too often under current driving conditions such as low traffic conditions. Red flag points may accumulate for each lane change over a threshold or accepted number of lane changes.

In another embodiment, server 120 aided by SW 126 may send a pre-prepared or dynamically generated text message through Internet network 101 via IPR 127 over Internet access line 128, to IPR 108. IPR 108 may route the message through any number of message servers like email or instant message or through a Web message utility on WP 107. The message may then be downloaded or pushed through WISP 110 and over the wireless network to mobile communications appliance 113. A copy of the message may be retained for the user at the website or at any network-connected instant message application protocol (IMAP) message server.

One with skill in the art will appreciate that the types of data that may be taken from mobile appliance 113 are limited only by the sensor capacities on the appliance. It is noted herein that sensors may be internally integrated with mobile telephone 113 and/or may be externally coupled to mobile appliance 113 such as through universal serial bus (USB) plug-in, or other external ports available for the purpose. In active monitoring, satellites may be used to glean location information and direction along routes. Cross-referencing location with mapping system can aid the system in determining the legal speed limits and traffic conditions along a route.

In one embodiment, the service of the invention may be provided with any existing network-based navigation service. In one embodiment, the vehicle operator docks the mobile communications appliance into a special hands-free bay while practicing the invention while driving. The system operates without the requirement of accessing any hardwired vehicle computer components such as a CPU or without depending on any hardwired vehicle sensors. In one embodiment, a user-operating vehicle 113 may login to web page 107 and view past driving behavior reports.

In a preferred embodiment, a user may have control over what specific data types are revealed to an insurance company through the system. In one embodiment, a third-party service provider that has access to several insurance providers provides the service. In this embodiment, the user identification and any specific route location information may be kept private. Data forwarded to the insurance company may be cleansed of any information associated with the vehicle or the vehicle operator. In this case, the service may act as a broker in determining if lower insurance premiums can be achieved by sharing pertinent facts of the driving behaviors and record of the user, then forwarding the name of the insurer to the user if the proposed rates might be lower that what the user currently pays.

In another embodiment, an insurance company may obtain the information from the third-party service for all of its insured users with all driving behavioral data of the users cleansed of user and location or route information. In this case, rate adjustments may be made across the board based on the aggregated statistics where a discount for good driving behaviors is applied to all policies based on all of the operation data reviewed for a period. For example, last month the incidences of driving at excessive rates of speed are statistically down for all drivers of a certain age group. This may be because these users registered with the third-party service and were coached toward better driving habits by interacting with the system over that period. Therefore, a rate adjustment to premiums may be calculated based on savings and all of the insured drivers that were participating in the third-party service may get a rate reduction, at least for the month reviewed. One important aspect of such an environment is that the insurance provider for all of those users is acting only on the service-aggregated information for all of the vehicle operations for the period and is not aware of individual records for individual drivers.

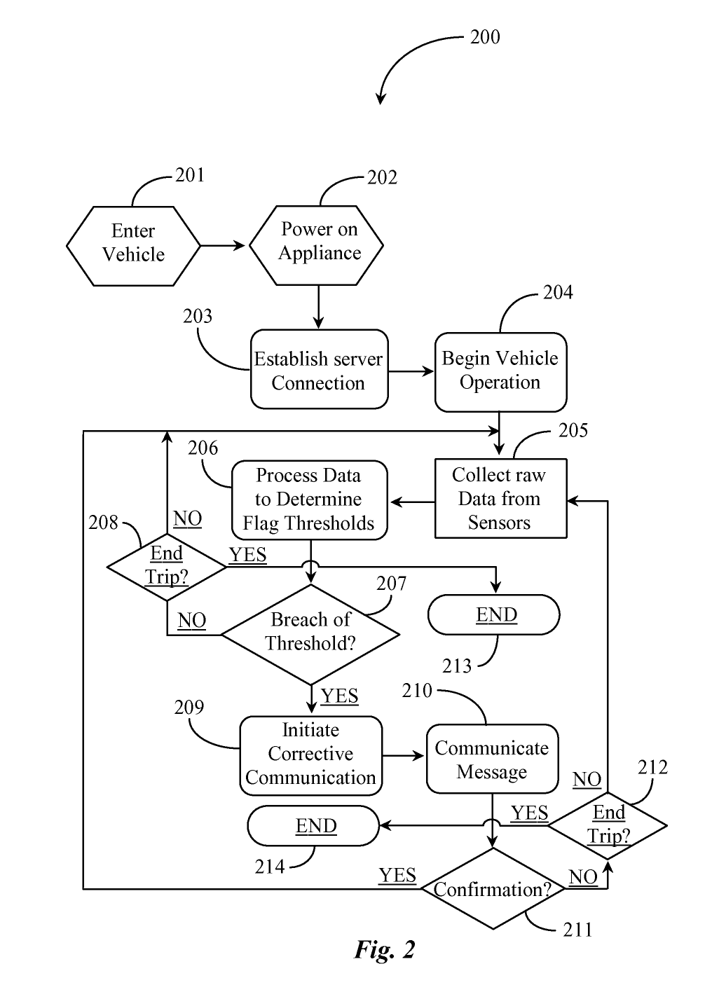

FIG. 2 is a process flow chart 200 depicting steps for collecting and processing vehicle operation data and for providing mitigating correction recommendations in real time according to the embodiment of FIG. 1. In this example, it is assumed that a user is registered to use the service of the present invention such as having registered through a website like web page 107 of FIG. 1. At step 201, a user enters the vehicle. In this case the vehicle may be assumed to be running At step 202, the user powers on the mobile communications appliance, if it is not already on.

At step 203, the user establishes a server connection with the monitoring server such as server 120 of FIG. 1. At step 204, the user begins operating the vehicle. If operation of the vehicle includes driving or navigating a pre-planned route, this route information may be forwarded to the server for reference. When the user is connected to the monitoring server and driving the vehicle, the user is considered online. In one embodiment, the mobile communications appliance is docked in a docking station or bay. At step 205, the server begins collection of raw sensor data from sensors on the mobile communications appliance. Collection of raw data may be continuous during vehicle operation, or it may be performed periodically during the trip.

At step 206, the system processes raw data from the sensors on the mobile appliance to determine flag threshold data. This is not required to practice the invention, but may aid in embodiments where corrective communication is offered to a vehicle operator during operation of the vehicle being monitored. Flag threshold data may include limits relative to acceleration, deceleration, speed excess, and speed during turning, etc. Some of these “threshold” limits depend upon the rules of the roadway the vehicle is on during data collection and processing. Many such threshold limits might be universal limits that are pre-prepared for comparison with raw data. For example, if a stretch of roadway has a 45-mile an hour speed limit, then 50 miles per hour may be a pre-set flag threshold limit for that roadway and other roadways that have a speed limit of 45 mph. A data collection of 55 miles per hour relative to sustained speed on a 45 mph roadway would be a breach then of the established red flag threshold established for that roadway. Red flag thresholds may be created and reused. Red flag threshold may also be mitigated in some embodiments by whether data, vehicle type and weight data, traffic count, and other factors.

At step 207, continued monitoring determines if there are any breaches of red flag data while vehicle operation ensues. Red flag thresholds might be pinned to specific parts of a travel route considering speed limits, traffic congestion, and other elements. At step 207, the system continues to collect and process raw data to determine if there are any red flag breaches. If there are one or more red flag breaches at step 207, then at step 208, the system may initiate corrective communications at step 209. The system may accomplish this task using text messaging or voice communication channels. The feedback could be provided through the application running on the mobile device. In one embodiment, the feedback could be pulled by the client or pushed by the server. The feedback can also be presented to the user through an alternative interface like a web browser on a desktop computer, laptop, or on a mobile device. The alternative interface or mobile device may also be used to control which information elements are shared with third parties like insurance companies. In this way, users may protect their privacy.

At step 210, the system communicates the message. For example, if a red flag threshold of 35 mph for a turn radius has been breached one or more times as evidenced by raw data collection and processing, such as average of sustained speed of 55 mph through the turn radiuses, then the system may determine that corrective communication is appropriate.

In one embodiment a text message (auto display message) may appear on the mobile appliance display screen that the operator may see without handling the appliance. In another embodiment a notification may pop up on the mobile device. In some instances corrective messaging may prevent an accident.

At step 211, the system determines if there has been any confirmation of receipt of such a corrective message or voice call. If a voice call is live, confirmation may be recognition by the system of answer of the call. A message receipt confirmation may be set to reply automatically to the system that the message was received and displayed on screen. A trip may end or be disrupted during data collection and monitoring. This fact is demonstrated by step 212 and step 208 in this process. These steps are operator determined and may come anytime during the process. The system may determine this by experiencing a disconnection or termination of the server connection. If the trip ends, then the process ends abruptly at step 214. Data collected during the trip may still be in process when a trip ends. In this case any updated information would be available to the operator through a web page like WP 107 of FIG. 1. At step 212, if the operator does not end the trip and thus the session, the process resolves to step 205 where raw data collection continues.

At step 207, if there are no breached thresholds, then the process might move to step 208 where the operator may end the trip as described further above. If the trip is not ended, the process resolves back to step 205 for continued collection of raw data. It is important to note that data collection may only be sporadic or periodic and not continuous. At step 208 if the trip ends, then the process ends at step 213. As previously discussed, data processing may continue for a period after the abrupt end of a trip. Similarly, an end of trip might be defined as a break from a pre-planned trip where the trip will resume once the break period ends. These periods may be randomly established by the operator and marked by server termination such as may be caused by removal of the mobile communications appliance from the process.

At step 211, if the system receives confirmation that the operator received a message, the process may still resolve back to step 205 for continued raw data collection and processing. It is noted herein that flag thresholds may be general and pre-established for most types of regional roadways like freeways, exit and entrance ramps, city streets, etc. In one embodiment red flag thresholds can be dynamically generated based on sensed and known conditions like weather, type of vehicle operated including center of gravity, wheel base length, weight of the vehicle, and so on. A mix of pre-established thresholds and dynamically created thresholds may be used in data processing. All of the collected and processed data may be forwarded to an insurance company for further analysis to determine if rate changes are appropriate for users or groups of users. Groups of users may include age groups, gender groups or some combination.

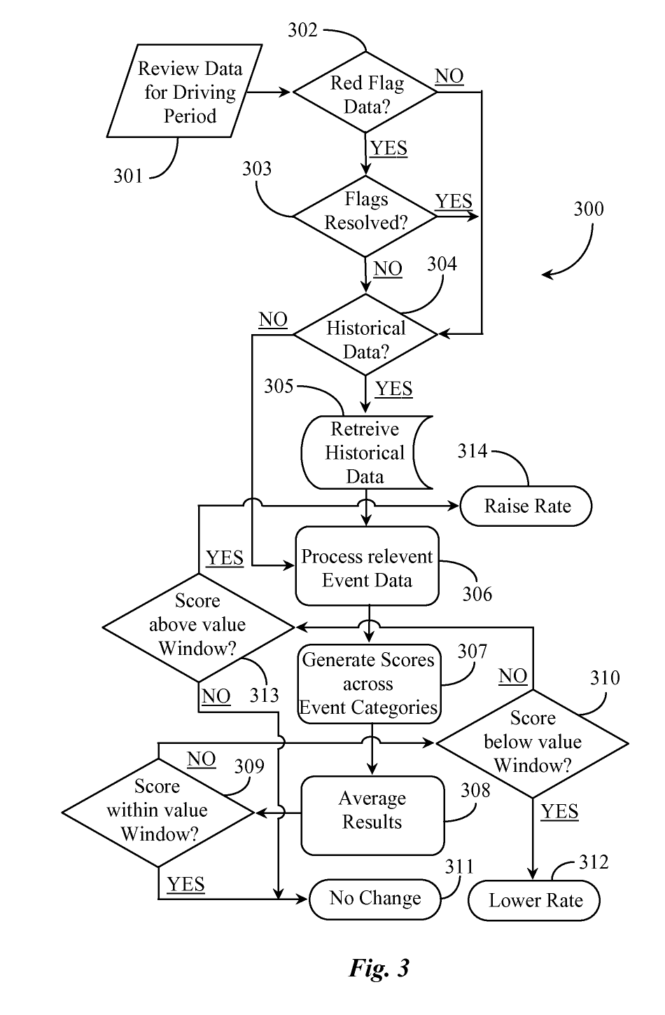

FIG. 3 is a process flow chart 300 depicting steps for processing collected data for the purpose of rate adjustment according to the embodiment of FIG. 1. This process may be a continuing process from process 200 of FIG. 2. At step 301, the insurance rating system receives review data for a driving period. This data may be data collected from many insured individuals or one monitored individual. A driving period may be a month, three months, six months, or some other established period. The data includes both vehicle operation data and driver behavior data.

At step 302, the system determines if there was red flag data (excesses of established thresholds). If there were no red flag data found at step 302, the process may skip to step 304. At step 304, the system determines if there are historical data associated with the evaluation. Historical data may be used for comparison with fresh period data. If the process is performed for an identified individual, then the historical data and red flag data would be generic to that individual only during the driving period reviewed. If the review is performed for a group of anonymous individuals identified, then the red flag data and historical data would be aggregated data that may also be summarized data to remove redundancy.

If there is red flag data found at step 302, the system checks if the fed flags were resolved at step 303. This data is available in the form of statistics relative to any records of corrective messages (resulting from one or more red flag breaches) placed to vehicle operators by the monitoring and data collection system, confirmations to those communications received at the monitoring and data collection system from the vehicle operators, and latest statistics relative to subsequent monitoring of those operators to determine if the corrective measures were ignored or implemented and if in the case of implementation, resulted in fewer threshold breaches.

Step 303 is not a required step in order to practice the present invention. However, information relevant to vehicle operator response to system messages or voice calls and evidence of correction in the field helps to gauge effectiveness of driver safety mitigation in real time. A positive result here may be used as a swaying factor or integral score in rate adjustment activity. The process moves from step 303 to step 304 regardless of whether threshold breaches were detected, corrective messages communicated and then resolved or not resolved in the field. This may be true for group data analysis for rate adjustment as well as for individual operator analysis for rate adjustment.

If historical data exists at step 304, the historical data is retrieved at step 305. It is noted herein that in the event of a single operator, it is possible that no historical data yet exists. In this case the operator may be newly insured and just registered with the service of the present invention. Moreover, in the case of a group, historical data may not exist for some in the group and at varying levels for others in the group. In the case of a group, privacy may be maintained by aggregating the historical data without identifying factors associated with whom the data belonged to.

At step 306, the relevant event data is processed against the historical data to evaluate spikes and trends in several categories. The categories serve to separate the data such as acceleration rates, deceleration rates, continued speeds, mileage counts, lane change frequency, sudden changes in direction, and like categories. Many different data categories may be created based on potential sensor input such as vibration (rough road, vehicle off roadway), shock (sudden stop, vehicle jolt, accident), and centrifugal force regulated by turn speed. The categories may also vary between individuals and groups, and types of insurance coverage or levels of coverage.

At step 307, scores may be generated across all of the event categories for which data exists. At step 308, the results may be averaged. It is noted herein that other values such as constants, buffers, variables, and the like may be integrated into one or more algorithm-driven sequences involved in processing the data without departing from the spirit and scope of the present invention. In this example, a pre-established value range or window is provided for comparison against the result value or “score” that represents the averaged results or step 308. At step 309, a determination is made whether the score of step 308 falls within the pre-established value range or window. If the score or value falls within the pre-established value range or window at step 309, then the process may end for that individual or group at step 311 where no rate change is indicated.

If the score resulting from step 308 does not fall within the pre-established value range or window at step 309, then the process moves to step 310. At step 310 it is determined if the score is below the pre-established value range or window. At step 310, if it is determined that the score falls below the pre-established value range or window, then the individual or groups rate may be lowered at step 312. The amount the rate will be lowered and whether the rate reflects a monthly bill, a six-month premium, or an annual premium depends at least in part on preferred design. If the score does not fall below the pre-established value range or window at step 310, the process moves to step 313. At step 313, it is determined whether the sore falls above the pre-established value range or window. If the score is above the pre-established value range, the process may end at step 314 with an indication of a rate increase. The amount the rate will be increased and whether the rate reflects a monthly bill, a six-month premium, or an annual premium depends at least in part on preferred design.

In one aspect of the present invention, a third-party service provider hosts data collection aggregation and data processing to results. In this case, historical data is generated, archived and recalled when needed to identify spikes or trends in certain data categories. The processed data may then be shared with the insurance company for the benefit of that company in the ability to more accurately adjust insurance rates for the covered operators that are registered with the third party service. In this respect, process 300 may be performed by the insurance company personnel or automated system based on the data received from the third-party host.

In another aspect of the invention, all of the data processing covered in processes 200 and 300 including rate adjustment is performed by a third-party service provider that contracts with the insurance company to lower the risks for that company. In this aspect, the insurance company cooperates by sharing preferred rate calculation processes and/or methods, as well as client information for registration and account management purposes. In still another embodiment of the present invention, an insurance company may practice the invention, such practice enabled through purchase and installation of the software of the invention with full authorization and license after purchasing a non-transitory physical medium containing the executable program(s).

It will be apparent to one with skill in the art that the system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

What is claimed is:

1. A system for analyzing sensor data output from a mobile communications appliance to adjust insurance premiums for consumers, comprising:
an Internet-connected server; and
software executing on the server from a non-transitory physical medium, the software providing:
a first function for collecting raw data from the mobile communications appliance;
a second function for analyzing the raw data in light of results of previous data analyses; and
third function for adjusting a standing insurance premium rate associated with the mobile communications appliance.

2. The system of claim 1, wherein the sensor data output includes one or a combination of rate of acceleration, continued average speed, rate of deceleration, incidence of shock force, incidence of centrifugal force, incidence of proximity to one or more objects, and frequency of lane change.

3. The system of claim 1, wherein the sensors include one or a combination of an accelerometer, a gyroscope, a location sensor, a light sensor, a proximity sensor, a microphone, a visual sensor, and a magnetometer.

4. The system of claim 1, wherein the mobile communications appliance is one of a cellular telephone, a notebook, a smart phone, or a hand-held navigation unit.

5. The system of claim 1, wherein the sensor or combination thereof resides internally and or externally on the mobile communications appliance.

6. The system of claim 1, wherein the results of analysis of the data are forwarded to an insurance company underwriter for review, comparison, and potential premium adjustment.

7. The system of claim 1, wherein the results of analysis of the data are forwarded to an automated system underwriter for automated review, comparison, and potential premium adjustment.

8. The system of claim 1, wherein the mobile communications appliance is docked to the vehicle while driving data is collected.

9. The system of claim 3, wherein the visual sensor is a camera capable of recording video.

10. The system of claim 1, further including a fourth function for forging a communications link to a user operating the mobile communications appliance.

11. The system of claim 10, wherein the system communicates correctional information for implementation to provide mitigation to the final data analysis.

12. A method for determining a rate adjustment for a vehicle insurance policy comprising the steps:
(a) monitoring one or more sensors operating on a mobile communications device while the vehicle is being operated;
(b) collecting data output from the one or more sensors;
(c) analyzing the data in light of previous data analyses;
(d) opening a communications link to the mobile communications appliance;
(e) communicating one or more correctional messages to mitigate results of the analysis; and,
(f) using the final data results to raise or lower the rate of premium paid on the insurance policy covering the vehicle operation.

13. The method of claim 12, wherein in step (a), the sensors include one or a combination of an accelerometer, a gyroscope, a location sensor, a light sensor, a proximity sensor, a microphone, a visual sensor, and a magnetometer.

14. The method of claim 12, wherein in step (b), the sensor data output includes one or a combination of rate of acceleration, continued average speed, rate of deceleration, incidence of shock force, incidence of centrifugal force, incidence of proximity to one or more objects, and frequency of lane change.

15. The method of claim 12, wherein in step (c), the previous results of data analyses are quantified and averaged over a pre-specified period of time.

16. The method of claim 12, wherein in step (d), the communications link is one of a data link or a voice link.

17. The method of claim 16, wherein in step (e), the voice link carries a live or automated voice communication from the insurance company to the operator of the mobile communications appliance.

18. The method of claim 16, wherein in step (e), the text link carries a live or automated text communication from the insurance company to the operator of the mobile communications appliance.

19. The method of claim 12, wherein the mobile communications appliances is one of a cellular telephone, a notebook, a smart phone, or a hand-held navigation unit.

20. The method of claim 12, wherein, in step (a), the one or more sensors reside internally and or externally on the mobile communications appliance.
